(19) United States
(12) Patent Application Publication
(10) Pub. No.: US 2015/0107950 A1
(43) Pub. Date: Apr. 23, 2015

(54) LOCKUP TORQUE CONVERTER WITH MULTI-RATE DAMPER

(71) Applicant: Renato Mauti, Farmington Hills, MI (US)

(72) Inventor: Renato Mauti, Farmington Hills, MI (US)

(21) Appl. No.: 14/058,408

(22) Filed: Oct. 21, 2013

(51) Int. Cl. F16D 33/18

(52) U.S. Cl. CPC F16D 33/18
USPC 192/3.28

(57) ABSTRACT

A launch device such as a torque converter for an automotive automatic transmission is provided. The torque converter has a lockup clutch which incorporates a multiple rate damper. The damper has a cam ring associated with one of the lockup clutch piston or turbine that is engaged by a spring loaded rotary member of the other of the lockup clutch or piston to provide multiple rate damping between the lockup clutch piston and turbine of the torque converter.

### FIELD OF THE INVENTION

The present invention relates to a launch device such as torque converters for automotive automatic transmissions. More particularly, the field of the present invention is that of launch devices such as torque converters for automotive automatic transmissions having a lockup clutch and an integral damper that is actuated upon engagement of the lockup clutch.

### BACKGROUND OF THE INVENTION

A torque converter is a type of hydraulic (fluid) drive launch device used to transfer rotating power from a prime mover, such as an internal combustion engine, to a rotating driven load. Virtually all torque converters have a cover shell with a front end for connection with the engine. A rear end of the cover has a series of blades that form a pump or impeller. Engine rotation of the cover causes the impeller to pump the fluid within the torque converter radially outward. Pressurized fluid from the impeller is directed to a turbine. The turbine redirects the fluid radially inward thereby powering an input shaft of an automatic transmission. Virtually all torque converters also have a stator which is interposed between the impeller and turbine so that it can alter the fluid drive flow returning from the turbine to the impeller. The use of the stator can affect torque multiplication between the impeller and the turbine. The power transmission from the impeller to the turbine provides a fluid connection between the same. The fluid drive connection between the turbine and impeller provides torsional damping from vibration that is induced by the periodic changes of velocity of the engine crankshaft due to the reciprocal nature of piston internal combustion engines. However, the fluid drive connection between the impeller and turbine comes at a cost of lower fuel efficiency because there is inherent slippage between the turbine and the impeller.

As the demands for fuel economy have increased, most torque converters have been provided with a lockup clutch. The lockup clutch includes a fluid pressure actuated plate piston. An engine or powertrain controller senses that the vehicle is in a state of operation wherein, for the time being, a shift in transmission gear ratio is not required. Upon this determination, the lockup clutch piston will be fluid pressurized to latch the turbine to a torque converter cover so that the turbine is mechanically rotated by the cover with no slippage in relationship to the impeller. When the lockup occurs, there is a lack of torsional damping due to the lack of the fluid drive connection between the impeller and the turbine. To compensate for this lack of dampening, there has been provided various torsional dampers (often referred to as dampeners). Many of the torsional dampers within torque converters have worked in a principal similar to that of torsional vibrational dampers in general. Typically, the lockup clutch piston or a plate associated therewith and the turbine are torsionally engaged with one another by coil springs captured in axially aligned circumferential slots provided in the piston and turbine. The coil springs provide torsional damping when the piston and turbine move angularly with respect to one another. An example of such a damping arrangement can be found in U.S. Patent Application Publication No. 2009/0151344 to Digler et al.

Because the coil springs are in circumferential spring retainer slots, damping is not as uniform as desired since the springs tend to want to return to their originally manufactured straight axis. Additionally, rotation of the piston and the turbine caused centrifugal force induced bending in the coil spring that hampers uniform damping by causing sliding friction with the spring retainer. The above noted conditions causes hysteresis (an amount of torque required to bring the damper back to zero after loading. It is essentially friction in the system).

It is desirable to provide a damper for the lockup clutch of a launch device such as a torque converter for an automatic transmission with less hysteresis.

### SUMMARY OF THE INVENTION

To meet the above noted and other manifold desires, a revelation of the present invention is brought forth. The present invention provides a launch device or torque converter for an automotive vehicle with a multiple rate damper for the lockup clutch. The launch device of torque converter of the present invention has a cam ring connected with the lockup clutch piston or turbine that is engaged by a spring loaded rotary member(s) of the torque converter the other one of the turbine to provide multiple rate damping between the lockup clutch piston and the turbine of the torque converter.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional schematic view of a torque converter launch device for an automotive automatic transmission according to the present invention;

FIG. 2 is a schematic rear view of the torque converter launch device shown in FIG. 1;

FIG. 3 is a graph illustrating a multiple rate damper;

FIG. 4 is a graph illustrating the damping curve of an infinitely variable multiple rate damper that can be provided by the torque converter shown in FIG. 1;

FIG. 5A is a schematic view of a rotary member utilizing a roller;

FIG. 5B is a schematic view of a rotary member utilizing a ball;

FIG. 6 is a sectional schematic view of an alternate embodiment damper of the present invention wherein the rotary member is connected with the piston plate rather than the turbine; and

FIG. 7 is a schematic rear view of the alternate embodiment of the present invention shown in FIG. 6.

### DETAILED DESCRIPTION OF THE PREFERRED EMBODIMENTS

The following description of the preferred embodiment(s) is merely exemplary in nature and is in no way intended to limit the invention, its application, or uses.

A torque converter 7 launching device according to the present invention is provided. The torque converter 7 includes a front cover 10. The front cover 10 along a forward end 12 is torsionally connected with the crank shaft of the prime mover. The prime mover is typically a reciprocating piston internal combustion engine. Due to the inherent design of reciprocating piston engines, there exists a vibratory oscillation about the mean velocity of the engine. The torque converter 7 front cover 10, at a rear end 14 is weldably connected to a rear cover 16. The rear cover 16 and front cover 10 define a first control volume 18. Fixably connected with the rear cover 16 is an impeller 22 formed by a plurality of impeller blades 23. Positioned within the control volume 18 is a turbine 24. The turbine 24 includes a series of blades 26 connected with a shell 28. The shell 28 is weldably connected with a two-part hub 30 including a plate 32 and an inner hub 34 that is splined to the input shaft 36 of an automotive transmission. Positioned between the impeller 22 and the turbine blade 26 is a stator 38. The stator 38 redirects flow coming from the turbine 24 back to the impeller 22. Slidably sealably mounted on the inner hub 34 is a plate piston 42. The plate piston 42 along its outer edge has an engagement surface 44. The engagement surface 44 or the interior of the front cover 10 or both may have friction materials 46 bonded thereto.

Fixably connected to the lockup clutch piston 42 by rivets or other suitable connective method, is a cam plate ring 50. The cam plate ring 50 has an interior cam surface 52. Engaged with the interior cam surface 52 of the cam ring 50 is a rotary member 56. In many applications, it is preferable to have multiple rotary members 56, preferably geometrically equally spaced from one another. In most applications, at least three rotary members are preferable. Radially biasing the rotary member 56 against the cam surface 52 is a coil spring 58.

In operation, the front cover 10 is torsionally connected with the crank shaft of an automotive vehicle. The rotation of the front cover 10 in turn also rotates the rear cover 16 causing the blades 23 of the impeller 22 to rotate. Rotation of the impeller 22 causes the fluid to go radially outward turning it into the blades 26 of the turbine 24 thereby causing rotation of the hub 30 and transmission shaft 36. A stator 38 is utilized to redirect the fluid flowing from the turbine 24 back to the impeller 22 to dictate a desired torque ratio between the impeller 22 and turbine 24. When it is desired to lockup the turbine 24 with the front cover 10 a pump (not shown) is utilized to pressurize the control volume 18 causing the piston 42 to be urged forward causing its frictional engagement portion 44 to latch to the front cover 10 via the friction material 46. The turbine 24 is now locked to the front cover 10 and impeller 22. The rotary members or rollers 56 are urged radially outward by the spring 58 so that it engages with the cam surface 52.

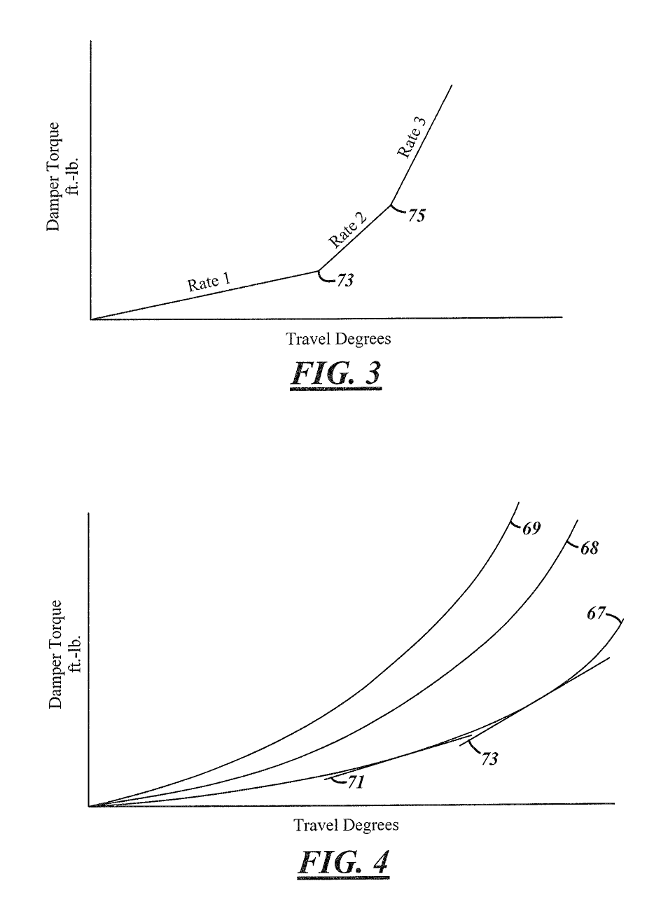

To dampen the torsional vibration received by the primary mover, the cam surface when laid out in a graph of damper torque versus displacement between the cam ring 50 and the rotary axis 64 of the rotary member (essentially a function of the relative angular displacement between the cam ring 58 and the hub 30) approaches that of curves 67, 68 or 69 of FIG. 4 depending upon the desired infinitely variable dampening torque versus travel profile desire. Each tangent 71, 73 of the curve provides a new damping ratio for the damper. For different vehicles, a new damping profile can be provided by just substituting the cam ring 50 for a cam ring having a slightly different interior cam surface 52 to provide the damping profile desired. Additionally, changes in spring stiffness can modify the damping profile.

If desired, the torque converter 7 of the present invention can have multiple rate dampening for lockup clutch similar to that of prior art torque converters having a damper torque versus travel degree curve as shown in FIG. 3. With the prior dampening configuration, the dampening surface was a compilation of straight-line segments. There was usually a sharp change between a first lower rate and a second higher rate of damping. The sudden transitions at 73, 75 can lead to jerkiness or vibration in the powertrain.

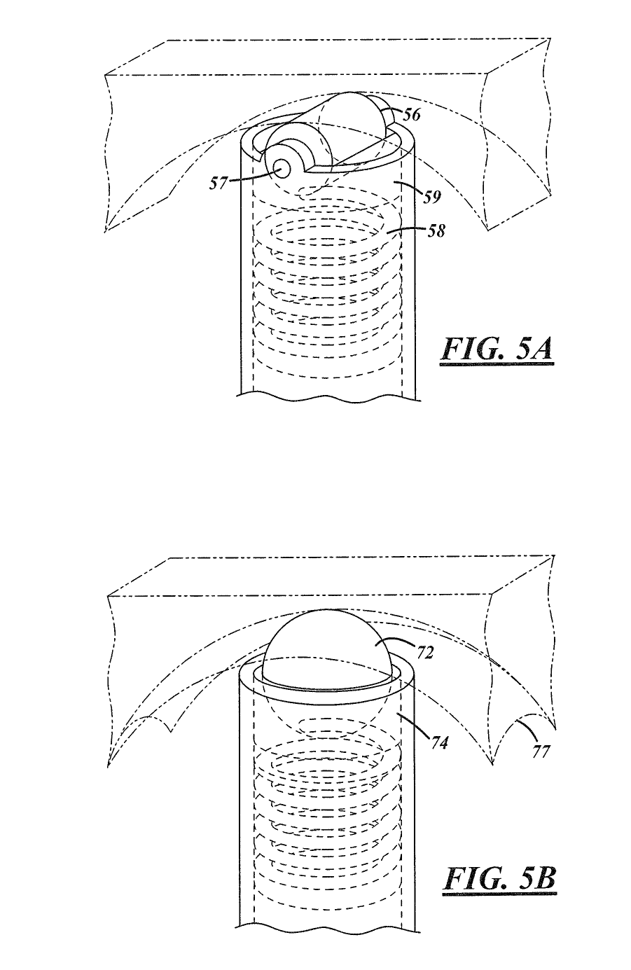

FIGS. 5A and 5B show in greater detail configurations for the rotary member 56. As best shown in FIG. 5A, the spring 58 is abutted against a cup 59. The cup 59 provides a support for the roller 56. The roller 56 rotates about a rotary axis 57. The rotary axis 57 can be accommodated by a shaft connected with the roller 56 which then is mounted in bearings provided by the cup 59 or the shaft can be attached to the cup 59 and the shaft providing a bearing surface for the roller 56. In another embodiment shown in FIG. 5B, the roller is substituted with a bearing ball 72 supported by a cup 74. With the bearing ball 72, an alternate cam ring design is provided shown in FIG. 7 having a transverse concave cam ring surface 77. As will be apparent to those skilled in the art, a concave cam surface 77 can also be utilized with a roller having a non-straight cylindrical profile. The concave cam surface provides axial stability for the damper.

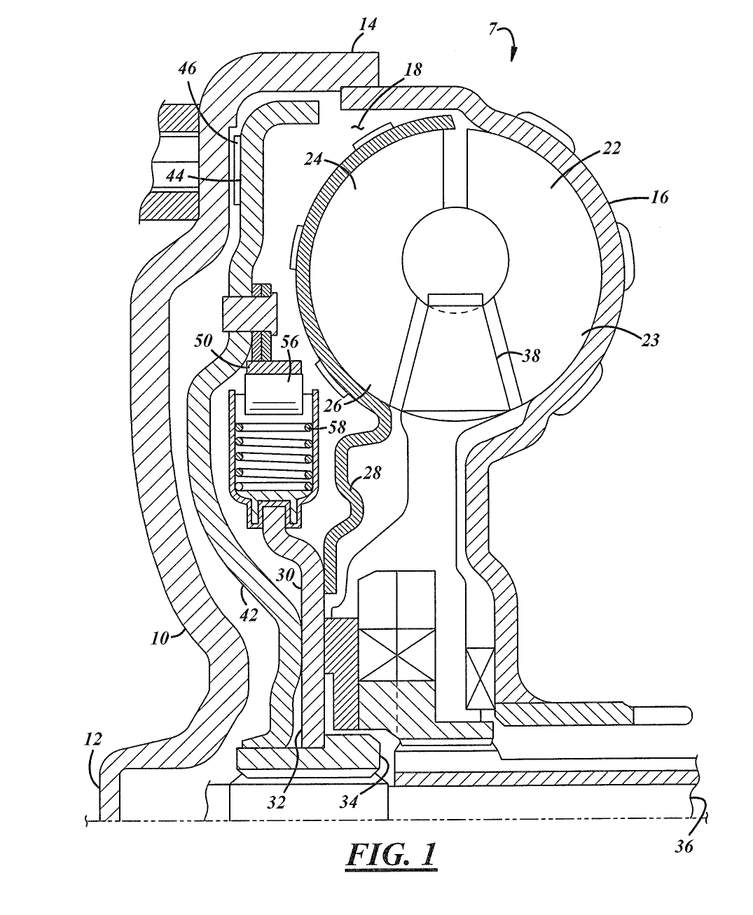

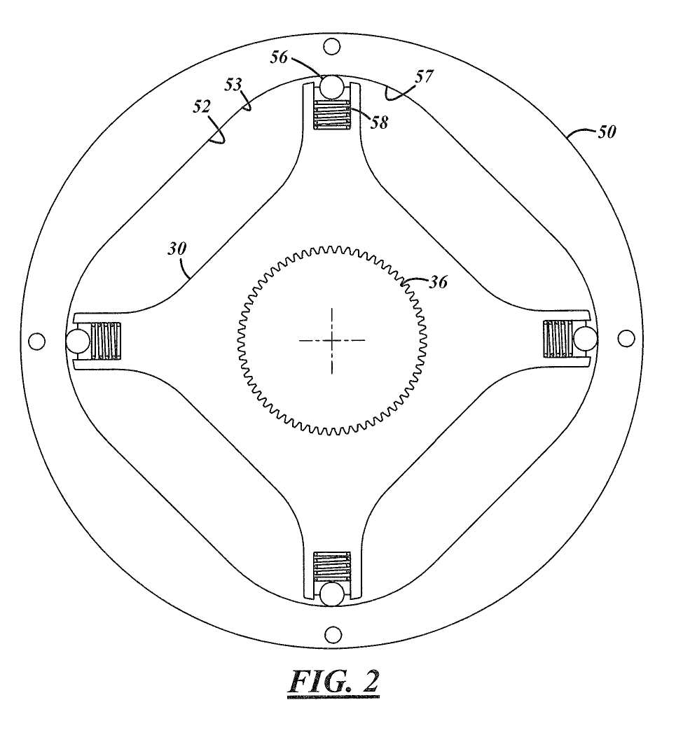

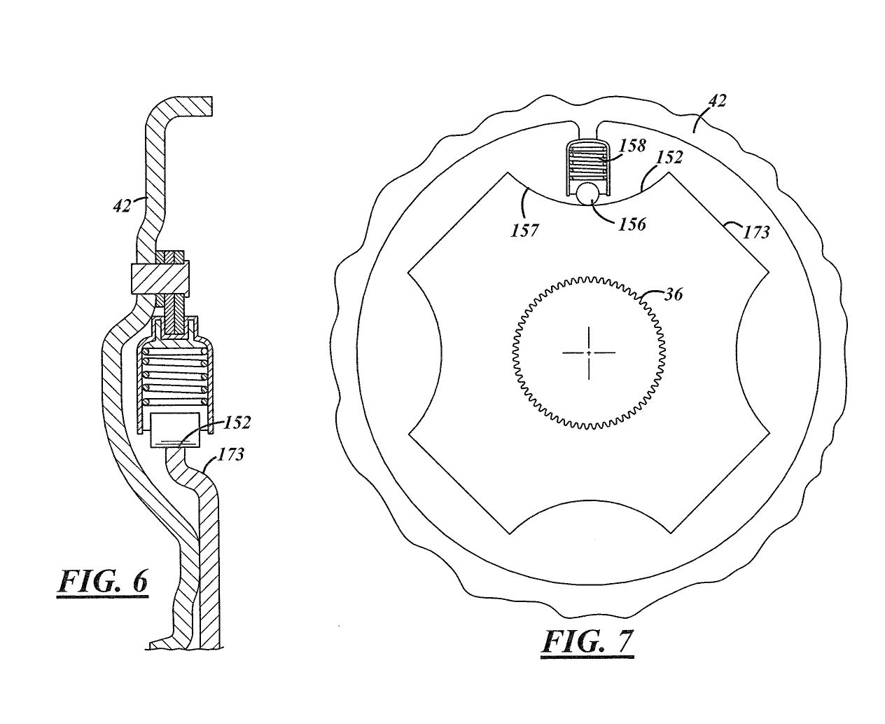

Referring to FIGS. 6 and 7, an alternate preferred embodiment of the present invention is brought forth wherein the rotary member 156 is connected with the piston plate 42, and the cam plate 173 provides a cam surface 152 is connected with the turbine 30. In this design, the biasing springs 158 urge the rotary member 156 radially inward rather than radially outward as shown in FIGS. 1 and 2. Accordingly, the cam surface 152 engages the roller 156. Additionally, the cam surface 152 can have slightly differing segments 157 and 159 to provide differing damping coefficients in the direction of relative rotational displacement between the piston plate and the turbine from the mean of angular movement of the torque converter. In a similar manner referring back to FIG. 2, cam surface 52 may have sub-cam surfaces 53 and 57 to differ the coefficient of damping based upon the differences in a direction from a mean of the relative rotational displacement of the turbine with respect to the piston plate. Typically, the slope of the damping curve in the direction when the accelerator of the vehicle (accelerator pedal) is being applied is less than when the vehicle is coasting (accelerator pedal is not being applied).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A launch device for an automotive automatic transmission comprising:
a front cover for torsional connection with an engine crank shaft;
a rear cover connected to said front cover forming a control volume therewith, said rear cover having an impeller connected thereto;
a turbine positioned within said control volume and being torsionally connected with an input shaft of a transmission;
a lockup clutch for mechanically latching said turbine to said front cover including a piston;
a multiple rate damper torsionally connecting said piston with said turbine, said damper including a cam plate connected with one of said piston and said turbine, said cam plate having a cam surface, said damper also including a rotary member connected with said other of said piston and turbine engaged with said cam surface of said cam plate; and
a compression spring biasing said rotary member radially against said cam surface.

2. A launch device as described in claim 1 wherein said launch device is a torque converter.

3. A launch device as described in claim 1 wherein said cam plate is a ring connected with said piston.

4. A launch device as described in claim 1 wherein said cam plate is connected with said turbine.

5. A launch device as described in claim 1 wherein said compression spring is a coil spring.

6. A launch device as described in claim 1 wherein there are multiple rotary members geometrically spaced from one another.

7. A launch device as described in claim 6 wherein said rotary members are equally spaced from one another.

8. A launch device as described in claim 1 wherein said rotary member is a ball.

9. A launch device as described in claim 1 wherein said cam surface has a transverse concave profile.

10. A launch device as described in claim 1 wherein said rotary member is a roller.

11. A launch device as described in claim 1 wherein said torque converter damper for said lockup clutch has at least three damping rates.

12. A launch device as described in claim 11 wherein said converter damper for said lockup clutch is infinitely variable.

13. A launch device as described claim 1 wherein the rate of damping differs due to differences in a direction from a mean of relative rotational displacement of the turbine with respect to the piston plate.

14. A launch device as described in claim 13 wherein the rate of damping when said launch device is undergoing acceleration is less than when the launch device is coasting.

15. A torque converter for an automotive automatic transmission comprising:
a front cover for torsional connection with an engine crank shaft;
a rear cover welded to said front cover forming a control volume therewith, said rear cover having an impeller connected thereto;
a turbine positioned within said control volume and being torsionally connected with an input shaft of the automotive automatic transmission;
a lockup clutch for mechanically latching said turbine to said front cover including a plate piston slidably mounted on a hub of said turbine;
an infinitely variable multiple rate damper torsionally connecting said piston with said turbine, said damper including a cam ring connected with said piston and said cam ring having an internal cam surface, said damper also including at least three geometrically spaced rotary members connected with said turbine engaged with said cam surface of said cam ring; and
a coil spring biasing each said rotary member radially outward against said cam ring cam surface.

16. A torque converter as described in claim 15 wherein said rotary member is a ball.

17. A torque converter as described in claim 15 wherein said rotary member is a rotor.

18. A method of angularly damping a torque converter with a lockup clutch connecting an automotive automatic transmission with an engine comprising:
providing a front cover for torsional connection with an engine crank shaft;
providing a rear cover welded to said front cover forming a control volume therewith, said rear cover having an impeller connected thereto;
positioning within said control volume and torsionally connecting with an input shaft of transmission a turbine;
providing a lockup clutch for mechanically latching said turbine to said front cover with a plate piston slidably mounted on a hub of the turbine by pressurizing the control volume to cause said turbine to be urged into frictional engagement with the front cover; and
infinitely variably damping torsional vibrations between the engine and the transmission by connecting with one of said piston and said turbine a cam plate having a cam surface and engaging with said cam surface a rotary member connected with said other one of said piston and turbine with said cam surface by a compression spring biasing said rotary member against said cam surface.

19. The method as described in claim 18 wherein damping rates differ based upon the relative position of the piston plate and the turbine with respect to one another from a mean position.

20. The method as described in claim 19 wherein damping rates are greater when coasting than when accelerating.
